(19) United States
(12) Patent Application Publication
(10) Pub. No.: US 2016/0029547 A1
(43) Pub. Date: Feb. 4, 2016

(54) SENSING THE SOIL PROFILE BEHIND A SOIL-ENGAGING IMPLEMENT

(71) Applicant: Deere & Company, Moline, IL (US)

(72) Inventors: Robert Thomas Casper, Mingo, IA (US); Rick B. Theilen, Altoona, IA (US); John M. Schweitzer, Ankeny, IA (US); Victor Saul Sierra, Waukee, IA (US); Noel Wayne Anderson, Fargo, ND (US)

(21) Appl. No.: 14/446,837

(22) Filed: Jul. 30, 2014

(51) Int. Cl. A01B 79/00; A01B 63/00

(52) U.S. Cl. CPC A01B 79/005; A01B 63/002; A01B 63/008; A01B 63/004

(57) ABSTRACT

A soil distribution indicator is generated, and indicates a soil distribution. An action signal is automatically generated based on the soil distribution indicator.

### FIELD OF THE DISCLOSURE

The present disclosure relates to soil-engaging implements. More specifically, the present disclosure relates to automatically sensing and controlling a soil profile behind a soil-engaging implement.

### BACKGROUND

There are a wide variety of different types of soil-engaging implements. In agriculture alone, there are numerous different implements that engage the soil in a field. For instance, such implements can include disks, multi-segment disks, chisel plows, implements with soil-engaging tools, such as rippers, and soil shaping disks, among a wide variety of others.

All of these types of soil-engaging implements, to some degree or another, distribute the soil behind them. For instance, a disk is often pulled by a tractor and can move soil to the right, or to the left, as it is being pulled. Some disks have a front set of blades, and a rear set of blades. The front set of blades is angled to distribute the soil in one direction (e.g., outwardly from a center point of the disk), and the rear set of blades is angled to distribute the soil in the opposite direction (e.g., inwardly relative to the center point).

The amount of soil that is distributed by each distributing element can depend on a number of different variables. For instance, it can depend on the depth with which the soil distribution element engages the soil. If it engages the soil more deeply, it distributes a greater amount of soil. It can also depend on the angle of the soil distribution element. For instance, where the soil distribution element is a gang of disk blades, set at a soil-engaging angle that is relatively sharp, it will distribute a greater amount of soil than if the angle is set relatively wide.

Therefore, depending upon how the soil-engaging implement is operated, it can create an uneven soil distribution behind it, as it travels over the soil. Continuing with the example where the front set of disk blades distributes soil outwardly relative to a center point, and the rear set of disk blades distribute soil inwardly, if the disk is not configured properly, it can result in an uneven soil profile. For instance, assume that the front set of disk blades is engaging the soil more deeply, or at a more severe angle, than the rear set of disk blades. In that case, a greater amount of soil may be distributed outwardly by the front disk blades, than is drawn back inwardly, by the rear disk blades. This can result in an uneven soil profile. For example, the amount of soil at the outward edge of the disk might be larger (e.g., mounded) relative to the amount of soil at the center of the disk.

This is only one example of a soil-engaging implement. It is also only one example of how such an implement can be operated in order to leave an uneven soil profile behind it. Many other examples exist as well.

The discussion above is merely provided for general background information and is not intended to be used as an aid in determining the scope of the claimed subject matter.

### SUMMARY

A soil distribution indicator is generated, and indicates a soil distribution. An action signal is automatically generated based on the soil distribution indicator.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one example of a soil-engaging system that includes a soil-engaging implement.

FIG. 2 is a block diagram showing some examples of a soil distribution mechanisms.

FIG. 3 is a block diagram showing some examples of control actuators.

FIG. 4 is a top view of one embodiment of a disk.

FIGS. 4A-4C show three examples of soil profiles.

FIG. 5 is a simplified flow diagram illustrating one embodiment of the operation of the system shown in FIG. 1.

FIG. 6 is a more detailed flow diagram illustrating one embodiment of the operation of the system shown in FIG. 1 in monitoring a soil profile and generating an action signal.

FIG. 7 is a flow diagram illustrating one embodiment of the operation of the system shown in FIG. 1 in performing an action based on the action signal.

FIG. 8 is a side view of one embodiment of a disk.

FIG. 9 is a rear view of one embodiment of a multi-segment disk.

FIG. 10 is a top view of one embodiment of a multi-segment disk.

FIG. 11 is a top view of one embodiment of the multi-segment disk shown in FIGS. 9 and 10 with soil-engaging tools and soil shaping disks disposed thereon.

FIG. 12 is a side view of a portion of the disk shown in FIG. 11.

### DETAILED DESCRIPTION

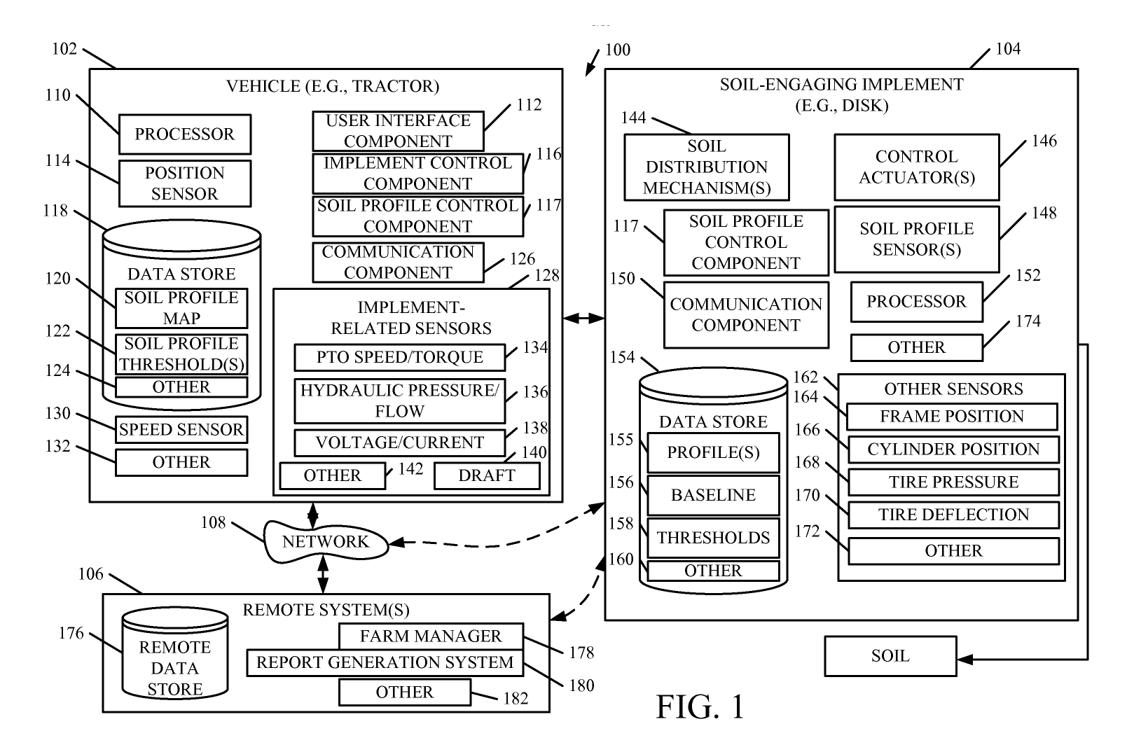

FIG. 1 is a block diagram of one illustrative embodiment of a soil-engaging system 100. System 100 illustratively includes vehicle 102 (for example, a tractor) and a soil-engaging implement 104 (for example, a disk). FIG. 1 also shows that, in one embodiment, either vehicle 102 or soil-engaging implement 104 (or both) can illustratively communicate with remote systems 106 either directly, or over a network 108.

Before describing FIG. 1 in more detail, it will be noted that FIG. 1 shows only one example of a soil-engaging system and a wide variety of others could be used as well. For instance, the present discussion will proceed with respect to soil-engaging implement 104 being a disk that is connected to the rear of vehicle 102, which will be described as a tractor, but a wide variety of other configurations can be used. Implement 104 can, for example, be any other type of tillage, planting, cutting, sand/soil grooming, transporting or spraying implement. It can be any implement that distributes soil. It can be connected to either the front or rear of vehicle 102, which can be a combine, a sprayer, a utility vehicle or a wide variety of other vehicles. In addition, soil-engaging implement 104 may be incorporated within the structure of vehicle 102, or otherwise arranged. These are examples only. Also, the example described herein will be for an embodiment in which the soil profile is sensed after the soil-engaging implement 104 passes over the soil. However, in another embodiment, the soil profile can be sensed before implement 104 passes over the soil as well. These are examples only.

In the example shown in FIG. 1, vehicle 102 can illustratively include processor 110, user interface component 112, position sensor 114, implement control component 116, soil profile control component 117, data store 118 (which itself can include one or more soil profile maps 120, soil profile thresholds 122, or other information 124), communication component 126, implement-related sensors 128, speed sensor 130, and it can include other components 132 as well. The implement-related sensors 128 can include a wide variety of different sensors, such as a power take off (PTO) speed or torque sensor 134, a hydraulic pressure or flow sensor 136, various voltage and current sensors 138, draft sensor 140 or various combinations of these or other sensors 142.

FIG. 1 also shows that soil-engaging implement 104 can illustratively include soil distribution mechanisms 144, control actuators 146, one or more soil profile sensors 148, communication component 150, processor 152, data store 154 (which itself, can include a soil baseline 156, one or more soil profile thresholds 158, or other information 160). Implement 104 can also include other sensors 162, such as frame position sensors 164, cylinder position sensors 166, tire pressure sensors 168, tire deflection sensors 170, and a host of other sensors 172. Implement 104 can also include other items 174 as well.

In the example shown in FIG. 1, remote systems 106 can include a variety of different systems. For instance, they can include one or more remote data stores 176, a computing system for a farm manager 178, a remote report generation system 180, or a wide variety of other remote systems 182.

Before describing the operation of system 100, a brief description of some of the components identified in FIG. 1 will first be provided. User interface component 112 illustratively provides a user interface for interaction by an operator of vehicle 102. It can include a display screen, devices for generating audio information, or other visual information (such as lights), or haptic feedback mechanisms that provide a haptic output. Position sensor 114 illustratively senses a position of vehicle 102. It can, for instance, be a global positioning system (GPS), a dead reckoning system, a LORAN system, or a wide variety of other position sensing systems. Implement control component 116 illustratively provides outputs to control various features of soil-engaging implement 104. Component 116 can include electronic, hydraulic, mechanical, or a wide variety of other outputs for controlling hydraulic features, electric features, pneumatic or mechanical features, or other features of implement 104. The operator of vehicle 102 may be located on vehicle 102. In other embodiments, vehicle 102 can be unmanned and the operator and user interface component 112 can be eliminated or located in a different location.

Soil profile control component 117 can be disposed on vehicle 102, or implement 104, or parts of component 117 can be disposed on both vehicle 102 and implement 104. It receives a signal from soil profile sensor 148 (described in greater detail below) indicative of the soil profile behind implement 104 and provides output signals that can be used to perform various actions (as also described below).

Communication component 126 illustratively communicates with soil-engaging implement 104 and remote systems 106. Therefore, it can include either a wireless communication component, a hard-wired communication component, or both. It can include a communication bus (such as a CAN bus), or a wide variety of other communication mechanisms for communicating information.

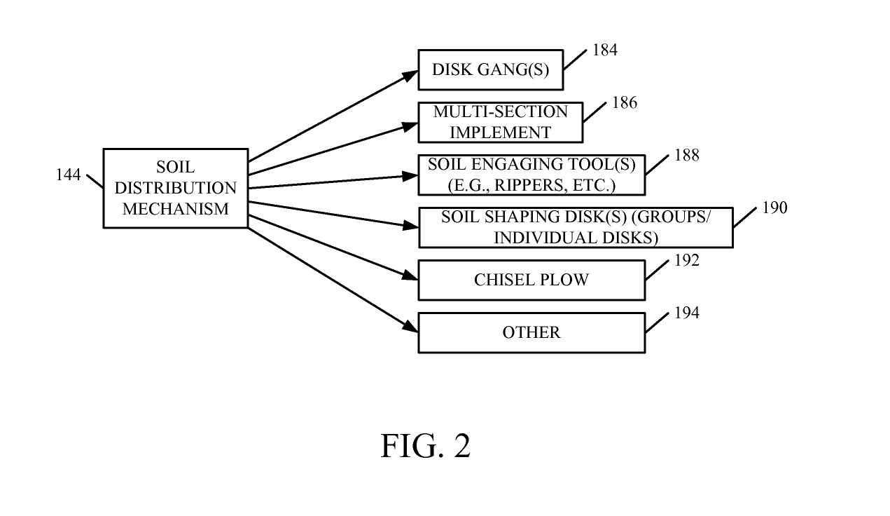

On implement 104, soil distribution mechanisms 144 can be a wide variety of different mechanisms. As shown in FIG. 2, for instance, soil distribution mechanisms 144 can include disk gangs 184, a multi-section implement 186, soil-engaging tools (such as rippers, etc.) 188, soil shaping disks (either controlled in groups or as individual disks) 190, chisel plows 192, or other soil distribution mechanisms 194 that distribute soil in various ways behind implement 104.

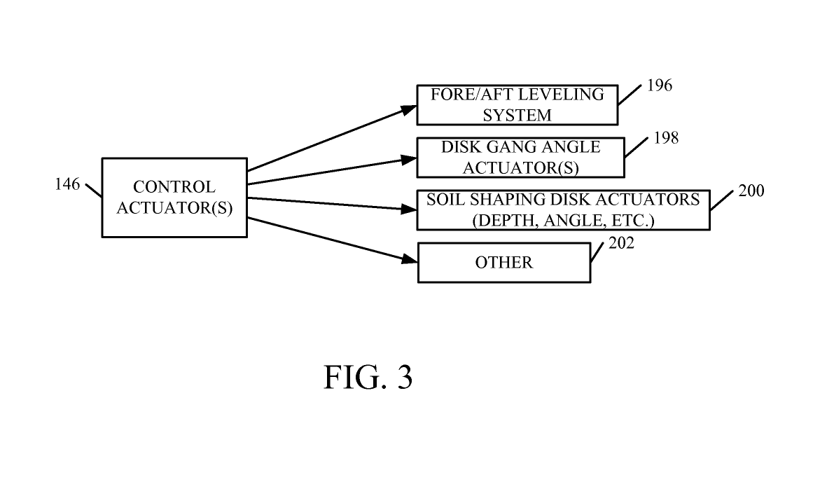

Control actuators 146 illustratively control soil distribution system 144 to control the amount, and direction, of soil distribution behind implement 104. Thus, by controlling control actuators 146, the soil profile behind implement 104 can be controlled. Actuators 146 can be manual or automatic actuators and can take a wide variety of different forms. For instance, FIG. 3 shows that they can include fore and aft leveling systems 196 for controlling the depth with which the soil distribution mechanisms 144 engage the soil. They can include disk gang angle actuators 198 that change the angle (relative to the direction of travel) with which the disk gangs on a disk engage the soil. They can be soil shaping disk actuators 200 that illustratively control the depth or angle (or both) with which soil shaping disks engage the soil. It will be noted that control actuators 146 can include other actuators 202, as well.

Soil profile sensor 148 illustratively and automatically obtains some indication of the soil profile behind implement 104. In one example embodiment, automatically means that a function is performed without any user inputs needed other than to enable, or turn on, the item performing the function. It will be noted that soil profile sensor 148 is shown on soil-engaging implement 104. However, it could also be disposed on vehicle 102, or in other locations, depending upon the particular implementation of the system.

For instance, in one embodiment, it generates an indication of the soil height, relative to a known reference point, behind implement 104, at various points in a direction generally offset from (e.g., perpendicular to) the direction of travel of implement 104. By way of example, if implement 104 is a disk where one segment of the disk distributes soil outward relative to a center point of the disk, and another disk segment distributes soil inward relative to that point, soil profile sensor 148 illustratively generates an indication as to whether soil is mounding on the outward or inward sides, or elsewhere.

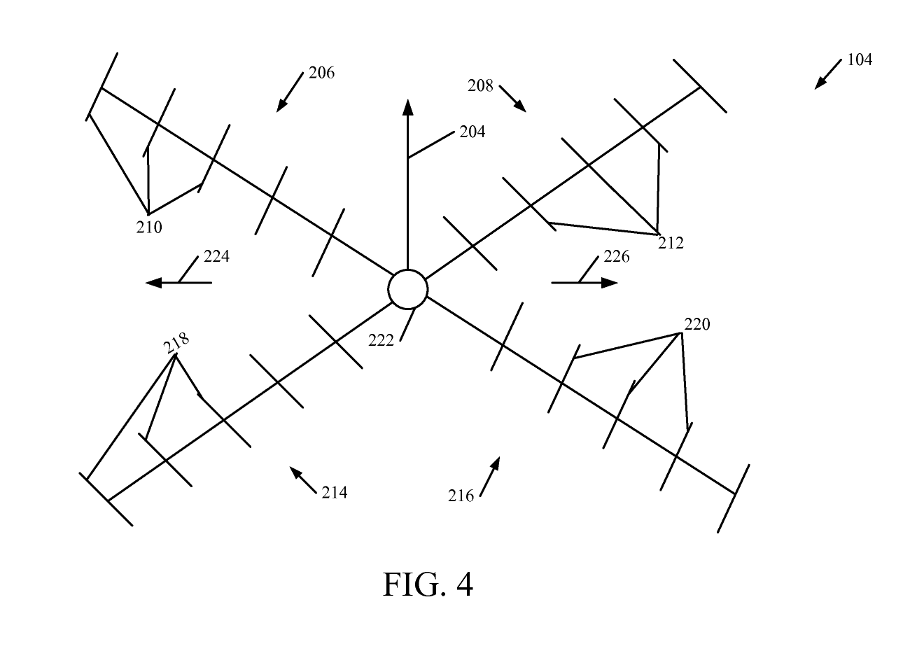

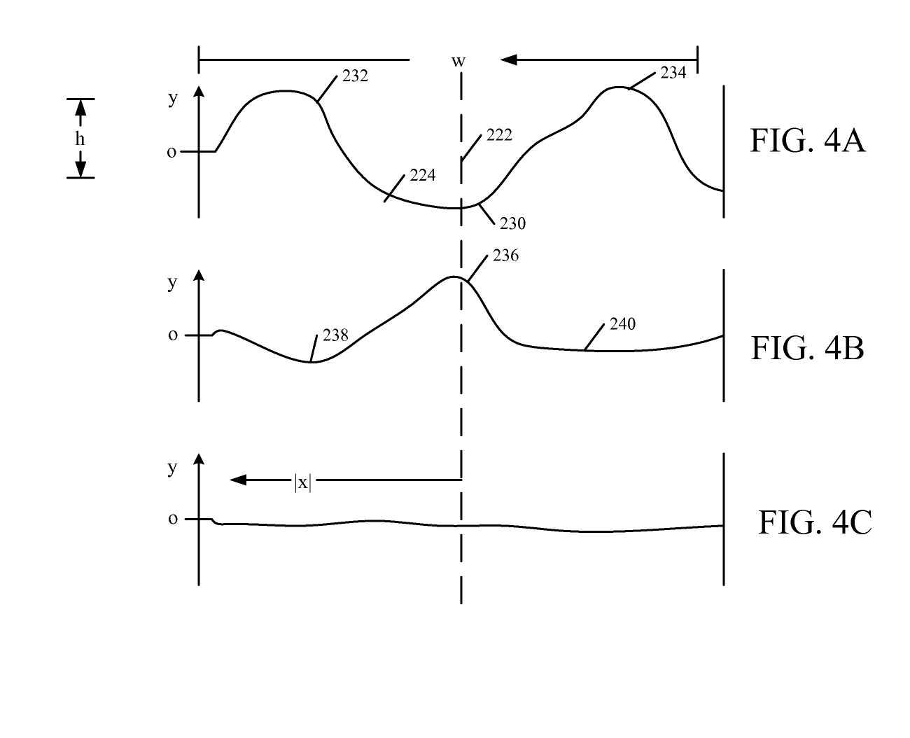

To illustrate this, FIG. 4 shows a top diagrammatic view of one exemplary implement 104. The implement 104 shown in FIG. 4 is a disk that includes four disk gangs. The disk travels in the direction indicated by arrow 204, and the disk gangs include two forward disk gangs 206 and 208 each of which have a plurality of disk blades 210 and 212, respectively. The disk gangs also include two rearward disk gangs 214 and 216, each of which include a plurality of disk blades 218 and 220, respectively. The angle of the front disk gangs relative to the direction of travel 204, and the angle of the rear disk gangs relative to the direction of travel 204 is illustratively controlled about a pivot point 222. For instance, each disk gang can be pivotably coupled about point 222, with its own, separately controlled actuator. The actuator can, for instance, be a hydraulic or electric (or other) actuator that can be controlled to vary the angle of its corresponding disk gang relative to the direction of travel. In another embodiment, the front disk gangs 206 and 208 are controllable as a unit, as are the rear disk gangs. It will also be noted that, in yet another embodiment, all four disk gangs can be controlled by a single actuator as well.

In any case, it can be seen from FIG. 4 that the front disk gangs are angled to distribute soil outwardly, in the directions indicated by arrows 224 and 226, relative to the central pivot point 222. The rear disk gangs 214 and 216 are angled to pull the soil back toward pivot point 222. Thus, if the front disk gangs 206 and 208 are distributing a greater amount of soil than the rear disk gangs 214 and 216, then the soil profile behind disk 104 will show that a low spot is developing toward the center of disk 104 and high spots are developing toward the outer portion of disk 104.

FIG. 4A shows one embodiment of such a soil profile. It can be seen that the width of disk 104 (between the outer disk blades on the disk gangs) is represented by “w” along an x axis that is generally perpendicular to the direction of travel of the disk 104. The height of the soil is represented by “h” along a y axis. In one embodiment, a baseline height of the soil is represented by “0” on the y axis. Therefore, the low spot 230 on the soil profile is represented by a negative number on the y axis, while the higher spots 232 and 234 are represented by positive numbers on the y axis. This is an example only and the soil profile can be represented in other ways as well. Regardless of how the soil profile is represented, FIG. 4A shows that disk 104 is preferentially distributing soil outwardly to leave a low spot in the center and high spots toward the outside.

FIG. 4B shows another soil profile in which the opposite is true. It can be seen in FIG. 4B that the soil profile shows a high spot 236 toward the center of disk 104 and low spots 238 and 240 toward the outside of disk 104. This can result from disk 104 preferentially distributing soil inwardly.

FIG. 4C shows a relatively flat soil profile. The soil level does not deviate from the baseline level by a very great degree, across the entire width of disk 104.

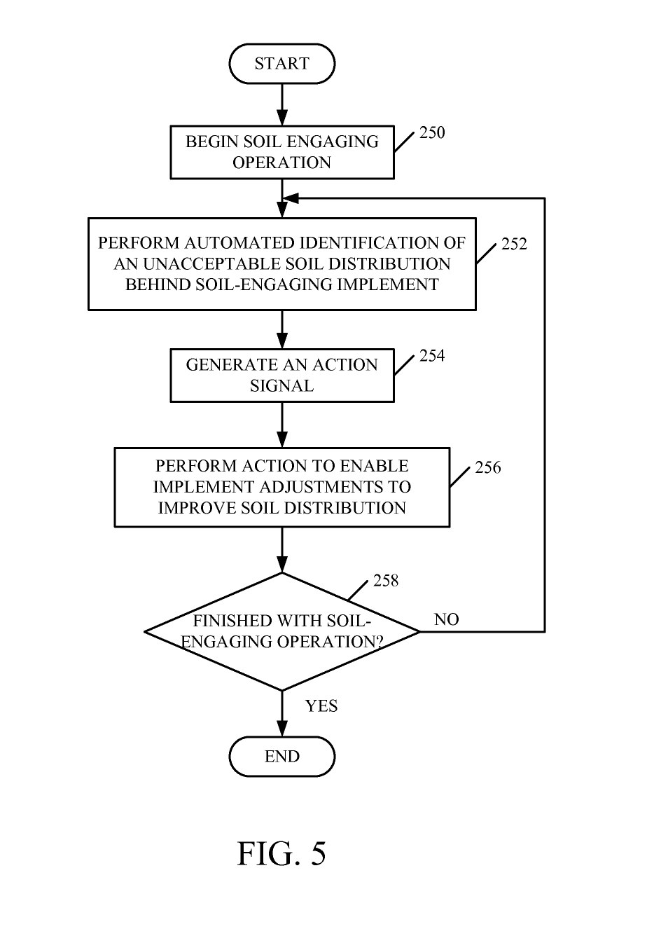

Soil profile sensor 148 illustratively obtains a representation of the soil profile behind implement 104. Thus, sensor 148 can be any of a wide variety of different items. For instance, it can include stereo cameras, a scanning lidar system, a structured light system, or a laser point time-of-flight system, among others. These systems can be mounted to capture images of the soil behind implement 104. The images can be used to obtain a two-dimensional or three-dimensional representation of the soil profile. It will also be noted that soil profile sensor 148 can include a single sensor, or multiple different sensors with overlapping (or non-overlapping) fields of detection mounted across the rear portion of implement 104. It can include a wide variety of other sensors as well. Some of these are described in more detail below with respect to FIG. 5.

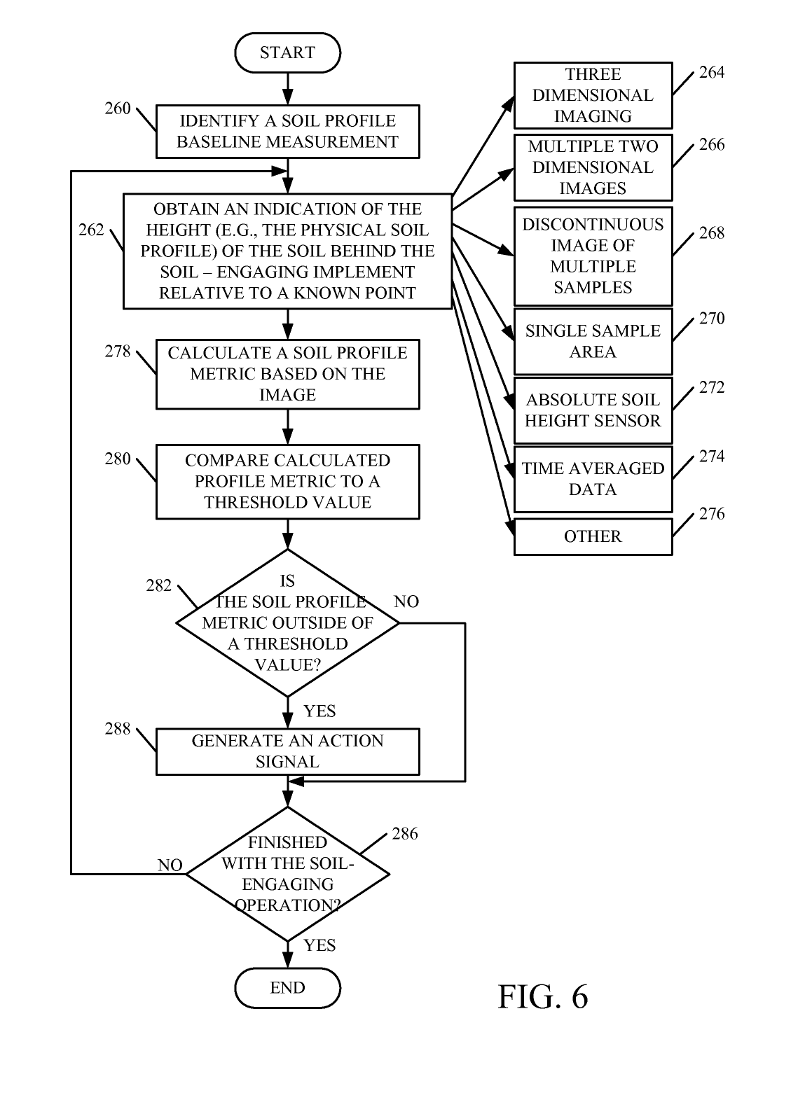

FIG. 5 is a simplified flow diagram illustrating one embodiment of the operation of system 100, in sensing and controlling the soil profile behind implement 104. It is first assumed that soil-engaging implement 104 is being used to perform a soil-engaging operation. This is indicated by block 250 in FIG. 5. By way of example, where implement 104 is a disk, it is assumed that the operator has begun the disking operation. Sensor 148 generates an output signal indicative of the soil profile behind implement 104 and soil profile control component 117 (either on vehicle 102 or on implement 104) illustratively receives the output signal from soil profile sensor 148 and identifies when an unacceptable soil distribution is occurring or is about to occur behind soil-engaging implement 104. This is indicated by block 252. Various ways for doing this are described below with respect to FIG. 6. In any case, component 117 illustratively generates an action signal indicating that the soil profile has reached an unacceptable level. This is indicated by block 254.

The operator, implement control component 116, or a control component on implement 104, or a wide variety of other components, can then perform an action to enable implement adjustments in order to improve the soil distribution. This is indicated by block 256 in FIG. 5. This can continue as long as the soil-engaging operation continues. This is indicated by block 258.

FIG. 6 shows a more detailed flow diagram of one embodiment of the operation of system 100 in identifying undesired soil profile conditions behind implement 104. In one embodiment, soil profile control component 117 first receives a signal from soil profile sensor 148 to identify (such as calculate or otherwise establish) a soil profile baseline measurement. This is indicated by block 260 in FIG. 6. By way of example, and referring again to the profiles in FIGS. 4A-4C, soil profile control component 117 identifies where the “0” level is on the soil profiles. This can be done in a wide variety of different ways.

For instance, when a structured light system is used, the baseline can be a horizontal line observed when implement 104 is operating on a flat surface. In some embodiments, this calibration can be performed once and the baseline value can be stored for later operation. In other embodiments (such as where a tillage implement comprises multiple sections which follow the contour of the land), the baseline calibration may be performed more frequently, as the contour of the land changes. In addition, a baseline may be obtained for each implement section to account for the contour of the land for that particular implement section.

In another embodiment, the baseline can be set by prompting the operator to identify a particular location over which implement 104 is traveling that has an acceptable soil profile. In that case, soil profile sensor 148 can generate an indication of the variations in the soil profile over that portion of the field, and the average soil level on the profile can be identified as the “0” level (or baseline level). Of course, these are only examples of different ways of identifying a soil profile baseline measurement, and a host of others could be used as well.

Once the soil profile baseline level has been obtained, soil profile sensor 148 obtains an indication of the soil profile relative to the baseline level. This can be represented by the height of the soil behind the soil-engaging implement 104, relative to a known point (such as relative to the baseline level). This is indicated by block 262. For instance, soil profile sensor 148 can use three-dimensional imaging as indicated by block 264. It can include multiple, two-dimensional images that are combined to obtain a three-dimensional image. This is indicated by block 266. It can include either a substantially continuous image across the entire width of implement 104, or it can include discontinuous images of multiple samples of ground, across the width of implement 104. This is indicated by block 268. It can also, for instance, include an image of a single sample area as indicated by block 270.

As an example of where a single sample area may be used, assume that implement 104 has a tendency to only pull soil toward one side, while other areas of the soil profile behind implement 104 remain relatively flat. This may be the case where implement 104 is a blade or scraper. In such an embodiment, it may be that the soil profile only near the one side of implement 104 needs to be sampled or otherwise sensed. If it becomes too high or too low, then the profile may be identified as unacceptable. Otherwise, it may be assumed that the soil profile is acceptable. This is only one example of where a single sample area may be used.

It should also be noted that soil profile sensor 148 may be an absolute soil height sensor as indicated by block 272. For instance, some GPS sensors sense not only longitude and latitude position, but altitude position as well. Some are quite accurate (to within centimeters, or fractions of centimeters). Therefore, if a GPS sensor is mounted on an item that follows the topology of the soil behind implement 104, it may provide an absolute indication as to the height (or altitude) of the soil. This can be compared to other points along the rear of implement 104, to obtain an indication of the soil profile.

It should also be noted that the data indicative of the soil profile can be time averaged in order to obtain a final soil profile indication. This can be helpful, for instance, to filter out the effects of dirt clods, plant residue, or other artifacts that may be present, but that are not representative of the tilled soil surface. Time averaging the data is indicated by block 274 in FIG. 6. Of course, other mechanisms for obtaining the indication of the soil profile can be used as well, and this is indicated by block 276.

Once the indication of the physical soil profile is obtained, component 117 calculates a soil profile metric based upon the physical soil profile. By way of example, where the physical soil profile is represented by a three-dimensional image, the soil profile will have a 0 (or near 0) deviation from the baseline level, on a flat surface. However, over a tilled field, for instance, most parts of the physical soil profile will either have a positive or negative deviation from the baseline level. This means that when the physical soil profile is generated on a display device, most pixels on the soil profile will deviate in either the positive or negative direction from the baseline value. These values will correspond to a soil surface that is above or below the flat, baseline level. Thus, in one embodiment, the calculated soil profile metric is calculated in terms of square pixels.

Equation one below can be used to calculate one example of the soil profile metric.

Soil metric=Σᵢ₌₁ⁿxᵢ*yᵢ Eq. 1

where n is the number of sample points across the width of interest (e.g., the width of the sampled portions behind disk 104), x is the distance from the defined center point on the soil profile image (e.g., the distance of displacement from the center pivot point 222 in the profiles shown in FIG. 4A-4C), and y is the deviation from the baseline in the y direction (e.g., h in the soil profile images shown in FIGS. 4A-4C).

Reference is again made to the soil profiles in FIGS. 4A-4C. With a relatively flat soil profile (e.g., in FIG. 4C), the soil profile metric calculated with equation 1 will be near 0. However, for the soil profile shown in FIG. 4B, the soil profile metric will have a relatively high negative value, because the positive y values near the center of the implement are multiplied by the small x values, while the negative y values at the outer edges of the implement are multiplied by the relatively large x values.

With respect to the soil profile shown in FIG. 4A, the soil profile metric will have a relatively high positive value. This is because the negative y values near the center of the implement are multiplied by the small x values, while the positive y values at the outer edges of the implement are multiplied by the relatively large x values. Calculating the soil profile metric based upon the image of the soil profiles is indicated by block 278 in FIG. 6. This is but one example of how the soil profile metric can be calculated.

Soil profile control component 117 then compares the calculated profile metric to a threshold value. This is indicated by block 280. This can be done in a variety of different ways as well. In one embodiment, the calculated soil profile metric is compared to a positive threshold and to a negative threshold. This is but one example only.

Component 117 then determines whether the soil profile metric has exceeded the threshold value (such as in either the positive or negative direction). This is indicated by block 282. If not, processing simply continues at block 262, until the soil-engaging operation is completed. This is indicated by block 286.

However, if, at block 282, the soil profile metric has exceeded the threshold value, then soil profile control component 117 generates an action signal. This is indicated by block 288. The action signal can take a wide variety of different forms.

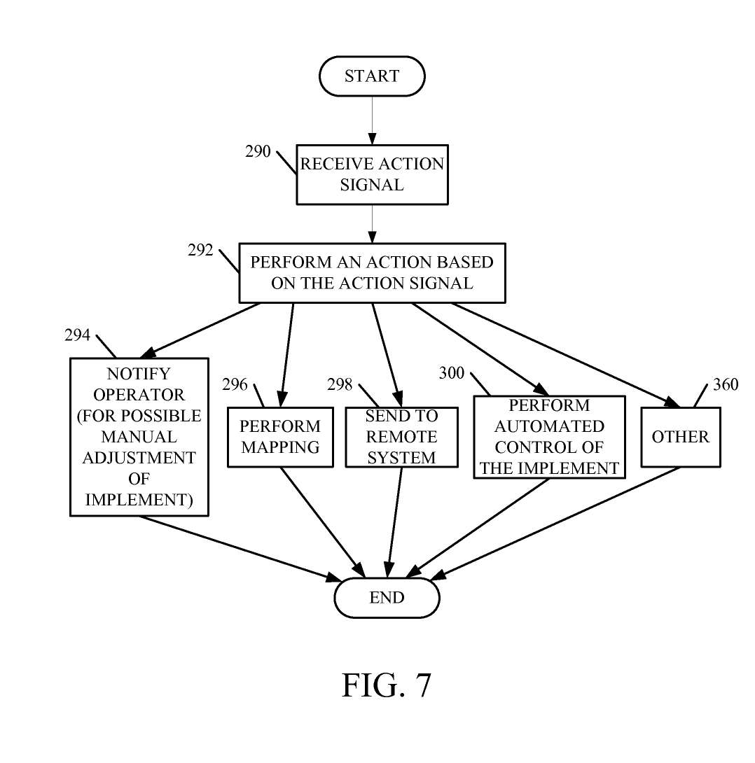

FIG. 7 is a flow diagram showing one embodiment of items that can be performed in response to the action signal. It is first assumed that component 117 has received the action signal. This is indicated by block 290 in FIG. 7. Component 117 (or a wide variety of other components) can then perform an action based upon the received action signal. This is indicated by block 292.

The actions can take a wide variety of different forms as well. For instance, one action can be to communicate using communication component 150, with control user interface component 112 where a suitable user interface notification can be generated in order to notify the operator. This is indicated by block 294 in FIG. 7. By way of example, the notification can be an audio notification, a visual notification, a haptic notification, or other types of notifications (such as combinations of these notifications). The operator can then make manual adjustments to soil-engaging implement 104 in order to attempt to improve the soil profile behind implement 104. Again referring to FIG. 4, the operator may make manual adjustments to the angles or depths with which the disk gangs engage the soil. Other manual adjustments can be made as well.

In addition, processor 110 can use the signal from position sensor 114, as well as the action signal, in order to perform soil profile mapping as indicated by block 296 in FIG. 6. This type of mapping can provide a map that indicates the soil profile as it varies across a field. It can also be a summary form of mapping in which problem areas are simply identified within a field, without representing the precise soil profile across the entire field. Other types of mapping can be performed as well.

The action signal can cause communication component 150 or communication component 126 to send information to a remote system. This is indicated by block 298. For instance, the remote system can be a remote data store as shown at 176 in FIG. 1, it can be a farm manager 178, it can be a remote report generation system 180 where it is used for the generation of a report, or it can be sent other remote systems 182. It will also be noted that it can be stored in data store 154 as profile 155, or it can be stored in data store 118 as well. Those data stores can be removable or fixed data stores.

In yet another embodiment, the action signal is provided to control actuators 146 in order to perform automated control of the soil distribution mechanisms 144 on implement 104. This is indicated by block 300. Referring again to the embodiment shown in FIG. 4, it may be that the disk gangs are controlled by automatically controllable actuators (such as hydraulic cylinders, electric motors, or other actuators) that can be controlled to selectively change the angle or depth of engagement of the disk gangs with respect to the soil. In that case, soil profile control component 117 can provide control signals to control actuators 146 in order to change the angle or depth of engagement in an attempt to improve the soil profile. There are a wide variety of other automated control operations that can be performed in response to the action signal. Other operations are indicated by block 360 in FIG. 7.

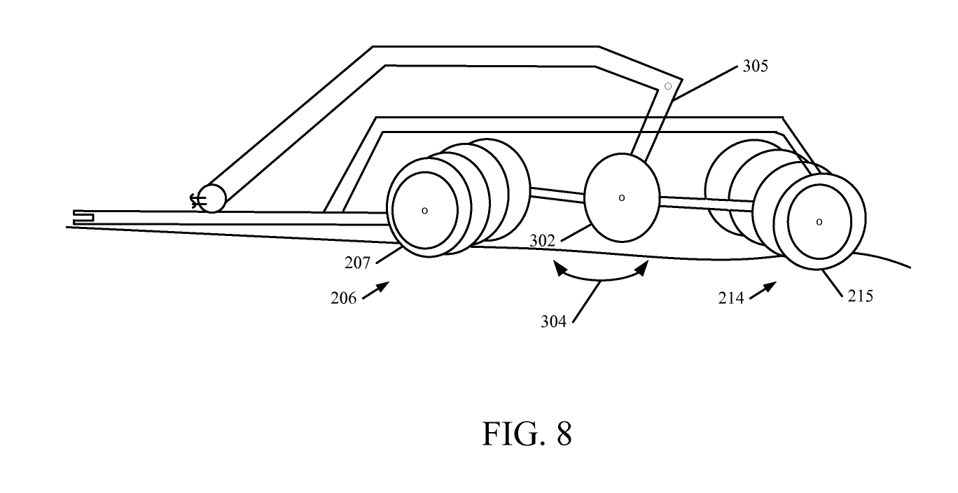

FIGS. 8-12 illustrate other embodiments in which either manual or automatic adjustments can be made in response to the action signal. FIG. 8 is a side view of the disk that embodies implement 104, shown in FIG. 4, but it also includes tires 207 and 215. FIG. 8 shows that, in one embodiment, a fore and aft leveling system 302 is generally located at a central portion of disk 104. It can be used to rotate or pivot the portions of the disk relative to one another, generally in the direction indicated by arrow 304, to increase the downward force on either the front set of disk gangs 206 and 208, or the rear set of disk gangs 214 and 216. This can be done manually or automatically using pivot actuator 305. This will change the depth with which the front and rear disk gangs are engaging the soil. By increasing the force on the front disk gangs, soil will be preferentially distributed in one direction (e.g., outwardly), while increasing the force on the rear disk gangs will preferentially distribute soil in the opposite direction (e.g., inwardly).

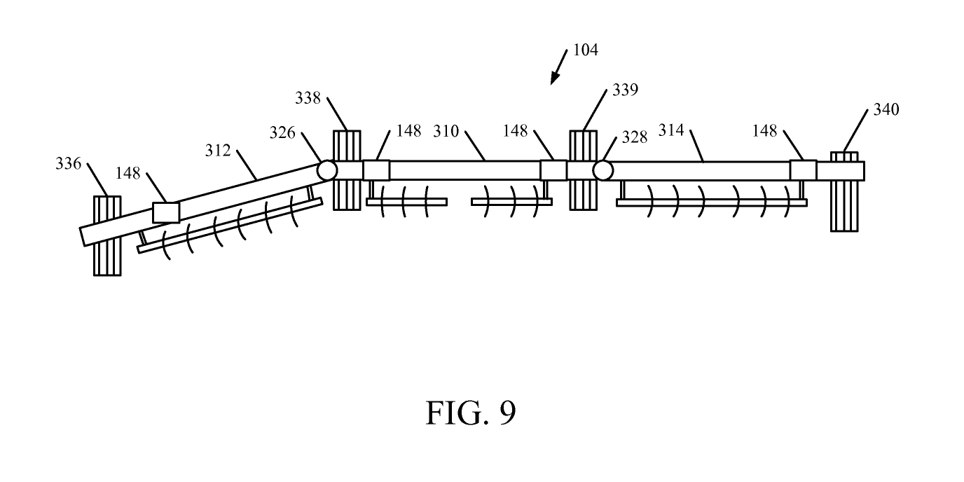

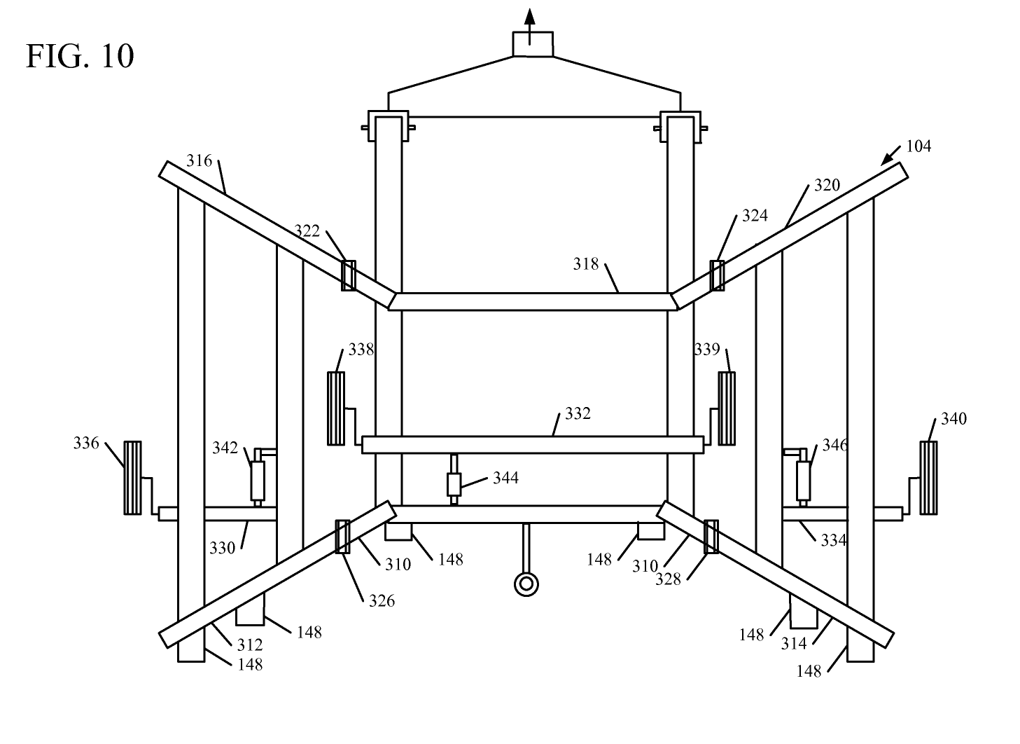

FIGS. 9 and 10 show two views of another embodiment in which soil-engaging implement 104 is a multi-segment disk. FIG. 9 is a rear view of the disk, while FIG. 10 is a top view of the disk. FIG. 9 shows that the rear disk gangs can include a central segment 310, a left hand outer segment 312, and a right hand outer segment 314. FIG. 10 also shows that there is a front left outer segment 316, a front central segment 318 and a front right outer segment 320. The front segments are pivotable (in the vertical direction) relative to one another about pivot points 322 and 324. The rear segments are pivotable relative to one another about pivot points 326 and 328. In one embodiment, the front segments can also be pivoted relative to the rear segments in the fore/aft direction. FIGS. 9 and 10 also show one embodiment in which a plurality of soil profile sensors 148 are mounted on a rearward portion of disk 104.

Each segment (the left segment, center segment and right segment) is illustratively coupled to frame members 330, 332 and 334, respectively. The frame members support wheels 336, 338, 339 and 340, respectively. The frame members are coupled to the disk segments by one or more actuators (such as hydraulic actuators 342, 344 and 346). By changing the relative extension of actuators 342-346, the corresponding disk segments can be raised or lowered relative to the corresponding tires. This raises or lowers the depth of engagement of that disk segment with the ground. For instance, if cylinder 342 is extended, it will lift the front and rear left hand outer segments 316 and 312, respectively, with respect to the center segment of the disk. In contrast, if cylinder 344 is contracted, for instance, it will lower the center segment of the disk relative to the left and right outer segments of the disk. Thus, by controlling cylinders 342, 344, and 346, the depth of engagement of the various segments of the disk shown in FIGS. 9 and 10 can be controlled to preferentially move material toward the center, or away from the center, of the disk. Of course, the placement of the actuators shown in FIGS. 9 and 10 is exemplary only and other configurations can be used as well.

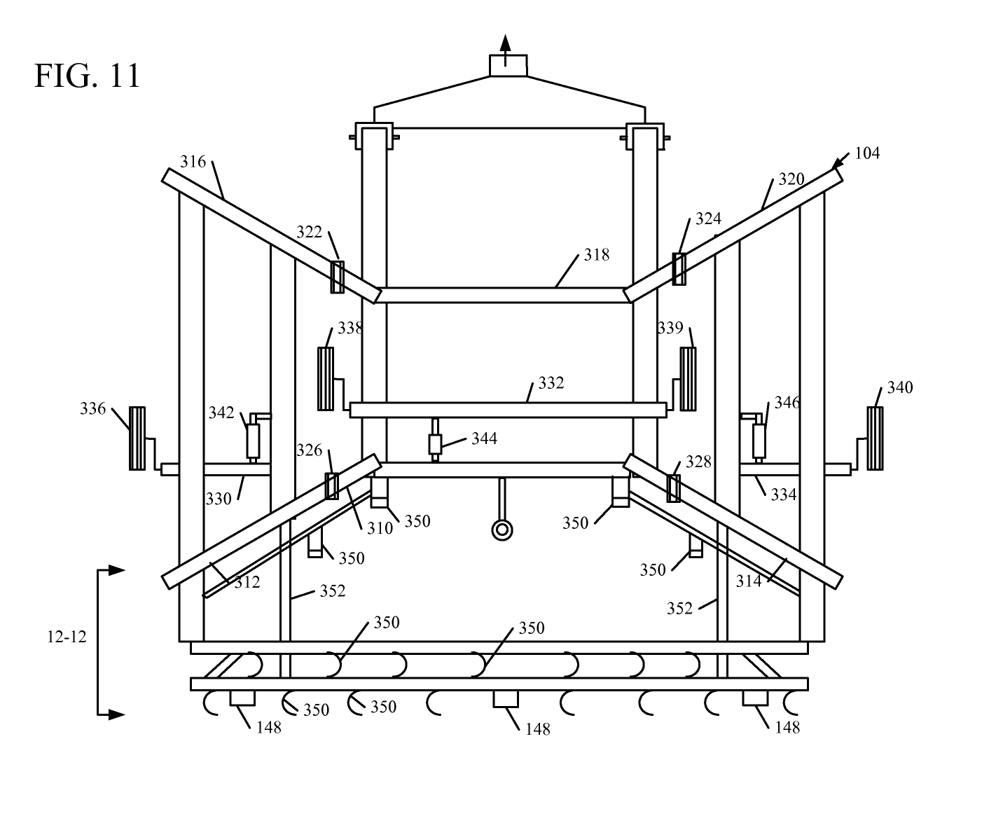

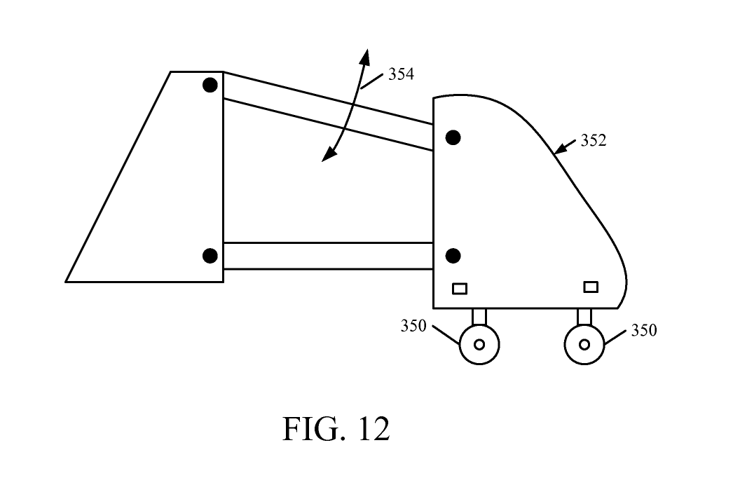

FIG. 11 shows a top view of the disk shown in FIGS. 9 and 10, except that the disk in FIG. 11 has soil engaging tools 350, and a soil shaping disk assembly 352 attached to it. FIG. 12 is a side view of a portion of the soil shaping disk assembly 352. The soil profile sensors 148 are mounted proximate to assembly 352. Soil engaging tools 350 can be rippers or other soil engaging tools, and the soil engaging disk assembly 352 can be positionable, generally in the direction indicated by arrow 354, relative to the remainder of the disk. Assembly 352 can be positioned using a suitable actuator (such as a hydraulic actuator, an electric motor, etc.). It can therefore be used to raise or lower soil shaping disks 350 on assembly 352.

It will be appreciated that there can be a separate assembly 352 and corresponding actuator, for each soil shaping disk, for pairs of soil shaping disks, or for a larger number of soil shaping disks or for all soil shaping disks, together. Therefore, in addition to having the actuators described with respect to FIGS. 9 and 10, the disk shown in FIGS. 11 and 12 can have additional actuators that are used to move soil shaping disks 350 so that they preferentially engage, or disengage, the soil. This can be done in order to modify the soil distribution (and hence the soil profile) behind implement 104.

The present discussion has mentioned processors. In one embodiment, the processors include computer processors with associated memory and timing circuitry, not separately shown. They are functional parts of the systems or devices to which they belong and are activated by, and facilitate the functionality of the other components or items in those systems.

Also, a number of user interface displays have been discussed. They can take a wide variety of different forms and can have a wide variety of different user actuatable input mechanisms disposed thereon. For instance, the user actuatable input mechanisms can be text boxes, check boxes, icons, links, drop-down menus, search boxes, etc. They can also be actuated in a wide variety of different ways. For instance, they can be actuated using a point and click device (such as a track ball or mouse). They can be actuated using hardware buttons, switches, a joystick or keyboard, thumb switches or thumb pads, etc. They can also be actuated using a virtual keyboard or other virtual actuators. In addition, where the screen on which they are displayed is a touch sensitive screen, they can be actuated using touch gestures. Also, where the device that displays them has speech recognition components, they can be actuated using speech commands. Other equipment control systems can include gesture recognition using cameras or accelerometers worn by the operator, as well as other natural user interfaces.

A number of data stores have also been discussed. It will be noted they can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

The processors can perform instructions stored on computer readable media. Computer readable media can be any available media that can be accessed by a computer and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computer. Communication media may embody computer readable instructions, data structures, program modules or other data in a transport mechanism and includes any information delivery media. The term “modulated data signal” means a signal that has one or more of its characteristics set or changed in such a manner as to encode information in the signal.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (e.g., ASICs), Program-specific Standard Products (e.g., ASSPs), System-on-a-chip systems (SOCs), Complex Programmable Logic Devices (CPLDs), etc.

It should also be noted that the different embodiments described herein can be combined in different ways. That is, parts of one or more embodiments can be combined with parts of one or more other embodiments. All of this is contemplated herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method of controlling a soil engaging implement, the method, comprising:
sensing a soil profile indicative of a soil distribution along an axis that is transverse to a direction of travel of the soil engaging implement; and
automatically generating a control signal that controls the soil engaging implement based on the sensed soil profile.

2. The method of claim 1 wherein sensing the soil profile comprises:
generating a soil distribution indicator indicative of the sensed soil profile.

3. The method of claim 2 wherein automatically generating control signal comprises:
determining whether the soil distribution indicator meets a threshold value; and
generating the control signal based on the determination of whether the soil distribution indicator meets the threshold value.

4. The method of claim 3 wherein sensing a soil profile comprises:
sensing a physical soil profile left by the soil-engaging implement by
obtaining a soil profile baseline value, and obtaining an indication of a height of the soil relative to the soil profile baseline value.

5. The method of claim 4 wherein the soil-engaging implement has a width that is generally parallel to the axis and wherein obtaining an indication of a height of the soil relative to the soil profile baseline value comprises:
sensing the indication of the height of the soil at a sample point along the implement axis.

6. The method of claim 5 wherein obtaining the indication of the height of the soil at a sample point along the axis comprises:
obtaining the indication of the height of the soil at a plurality of sample points along the axis.

7. The method of claim 6 wherein obtaining the indication of the height of the soil at a plurality of sample points along the axis comprises:
obtaining the indication of the height of the soil substantially continuously along the axis for at least the width of the soil engaging implement.

8. The method of claim 4 wherein obtaining the indication of the height of the soil comprises:
obtaining an image of the soil after the soil is engaged by the soil-engaging implement; and
determining a soil profile metric from the image of the soil.

9. The method of claim 8 wherein the soil profile metric is indicative of a measure of uneven soil distribution by the soil-engaging implement.

10. The method of claim 8 wherein obtaining an image of the soil comprises:
obtaining a three dimensional image of the soil.

11. The method of claim 8 and further comprising one of:
generating an operator notification based on the soil profile metric; or
generating a soil profile map by obtaining position data indicative of a position of the soil-engaging implement, and generating the soil profile map based on the soil profile metric and the position data.

12. A soil-engaging system, comprising:
a soil-engaging implement that moves in a direction of travel and includes a soil-engaging element that engages soil; and
a soil distribution sensor configured to sense a soil distribution of soil along an axis that is transverse of the direction of travel and generate a sensor signal indicative of the sensed soil distribution.

13. The soil-engaging system of claim 12 and further comprising:
an actuator coupled to the soil-engaging element to adjust the soil-engaging element to change the soil distribution based on the sensor signal.

14. The soil-engaging system of claim 13 wherein the soil distribution sensor comprises:
a camera mounted to a portion of the soil-engaging implement to obtain an image of the soil after the soil-engaging element of the soil-engaging implement has engaged the soil.

15. The soil-engaging system of claim 13 wherein the soil-engaging implement has a width that is generally perpendicular to a direction of travel of the soil-engaging implement, and further comprising:
a soil profile control system that receives the sensor signal and determines a metric indicative of an evenness of the sensed soil distribution along the width of the soil-engaging implement and generates an action signal based on the metric.

16. The soil-engaging system of claim 15 wherein the soil profile control system generates the action signal to control the actuator to modify the soil distribution based on the metric.

17. The soil-engaging system of claim 16 wherein the soil engaging implement comprises:
a disk with a first disk gang that distributes soil in a first direction relative to the width of the disk and a second disk gang that distributes soil in a second direction relative to the width of the disk, wherein the actuator changes a depth or angle with which at least one of the first and second disk gangs engages the soil, and wherein the soil profile control system generates the action signal to control the actuator to adjust the depth or angle with which at least one of the first and second disk gangs engages the soil to modify the soil distribution based on the metric.

18. The soil-engaging system of claim 15 and further comprising:
an operator interface device, the soil profile control system providing the action signal to generate an operator notification on the operator interface device based on the metric.

19. The soil-engaging system of claim 15 and further comprising:
a position sensor generating a position sensor signal indicative of a position of the soil-engaging implement, wherein the soil profile control system generates a soil profile map indicative of the soil distribution at various positions, based on the sensor signal from the soil distribution sensor and based on the position sensor signal.

20. The soil-engaging system of claim 15 and further comprising:
a communication component that is coupled to the soil profile control system and communicates the sensed soil distribution to a remote system.
